(19) United States
(12) Patent Application Publication
(10) Pub. No.: US 2025/0226781 A1
(43) Pub. Date: Jul. 10, 2025

(54) MOTOR CONTROL DEVICE AND MOTOR CONTROL METHOD

(71) Applicant: HITACHI ASTEMO, LTD., Hitachinaka-Shi, Ibaraki (JP)

(72) Inventors: Yasuaki SATO, Hitachinaka-shi, Ibaraki (JP); Takafumi HARA, Tokyo (JP); Takaya TSUKAGOSHI, Hitachinaka-shi, Ibaraki (JP); Katsuhiro HOSHINO, Hitachinaka-shi, Ibaraki (JP)

(73) Assignee: HITACHI ASTEMO, LTD., Hitachinaka-Shi, Ibaraki (JP)

(21) Appl. No.: 18/703,133

(22) PCT Filed: Oct. 22, 2021
(86) PCT No.: PCT/JP2021/039110

§ 371 Date: Apr. 19, 2024

(51) Int. Cl. H02P 23/30; H02P 23/14; H02P 27/14

(52) U.S. Cl. CPC H02P 23/30; H02P 23/14; H02P 27/14

(57) ABSTRACT

The motor control device that controls driving of a motor connected to a power converter performing power conversion from DC power to AC power, the motor driven using the AC power, includes a carrier wave generation unit that generates a carrier wave, a carrier wave frequency adjustment unit that adjusts the frequency of the carrier wave, and a gate signal generation unit that generates a gate signal for controlling operation of the power converter by performing pulse width modulation of a voltage command corresponding to a torque command using the carrier wave, and the carrier wave frequency adjustment unit adjusts the frequency of the carrier wave in accordance with the torque command and the rotation speed of the motor so that a phase of pulsating torque due to command current generated by the pulse width modulation using the carrier wave overlaps a phase of pulsating torque due to interlinkage magnetic flux of the motor within a predetermined phase difference.

### TECHNICAL FIELD

The present invention relates to a motor control device and a motor control method.

### BACKGROUND OF THE INVENTION

### Background Art

A motor is constituted by interlinkage magnetic flux such as a magnet embedded in a rotor and a coil wound around a stator. Therefore, torque pulsation is generated in the motor depending on the shape of the interlinkage magnetic flux. While the motor is driven by an inverter circuit, torque pulsation is also generated by harmonics included in the current supplied from the inverter circuit to the motor coil due to the control by pulse width modulation of the inverter circuit.

PTL 1 discloses an apparatus for adjusting the carrier wave frequency fc so as to reduce the pulsating torque by changing the voltage phase error Δθv representing the phase difference between the three-phase voltage commands Vu*, Vv*, Vw* and the triangular wave signal Tr based on the torque command T* and the rotation speed ωr of the motor.

### CITATION LIST

### Patent Literature

PTL 1: Japanese Laid-Open Patent Publication No. 2021-83276

### SUMMARY OF INVENTION

### Technical Problem

In the apparatus disclosed in PTL 1, there was a problem that the torque of the motor decreased.

### Solution to Problem

The motor control device according to the present invention, which is a motor control device that controls driving of a motor connected to a power converter performing power conversion from DC power to AC power, the motor driven using the AC power, includes a carrier wave generation unit that generates a carrier wave, a carrier wave frequency adjustment unit that adjusts frequency of the carrier wave, and a gate signal generation unit that generates a gate signal for controlling operation of the power converter by performing pulse width modulation of a voltage command corresponding to a torque command using the carrier wave, and the carrier wave frequency adjustment unit adjusts the frequency of the carrier wave in accordance with the torque command and the rotation speed of the motor so that a phase of pulsating torque due to command current generated by the pulse width modulation using the carrier wave overlaps a phase of pulsating torque due to interlinkage magnetic flux of the motor within a predetermined phase difference.

The motor control method according to the present invention, which is a motor control method in a motor control device that controls driving of a motor connected to a power converter performing power conversion from DC power to AC power, the motor driven using the AC power, includes generating a carrier wave, adjusting frequency of the carrier wave, generating a gate signal for controlling operation of the power converter by performing pulse width modulation of a voltage command corresponding to a torque command using the carrier wave, and adjusting the frequency of the carrier wave in accordance with the torque command and the rotation speed of the motor so that a phase of pulsating torque due to command current generated by the pulse width modulation using the carrier wave overlaps a phase of pulsating torque due to interlinkage magnetic flux of the motor within a predetermined phase difference.

### Advantageous Effects of Invention

According to the present invention, the torque of the motor can be increased as necessary.

### BRIEF DESCRIPTION OF DRAWINGS

FIG. 1 is a system configuration diagram of a motor control device.

FIG. 2 is a configuration diagram of an inverter circuit.

FIG. 3(A) (B) is a diagram showing pulsating torque.

FIG. 4 is a block diagram of a carrier wave frequency adjustment unit.

FIG. 5 is a block diagram of a voltage phase error calculation unit.

FIG. 6 is a diagram showing a torque enhancement phase difference table related to Example 1.

FIG. 7 is a diagram showing a torque enhancement phase difference table related to Example 2.

FIG. 8 is a block diagram of a voltage phase error calculation unit in Variation 1.

FIG. 9 is a block diagram of a voltage phase error calculation unit in Variation 2.

FIG. 10 is a diagram showing a torque enhancement phase difference table related to Example 3.

FIG. 11 is a block diagram of a voltage phase error calculation unit in Variation 3.

### DESCRIPTION OF EMBODIMENTS

Embodiments of the present invention will now be described with reference to the drawings. The following descriptions and drawings are illustrative examples of the present invention and have been omitted and simplified as appropriate for clarity of the description. The present invention may be implemented in various other forms. Unless otherwise specified, each component may be singular or plural.

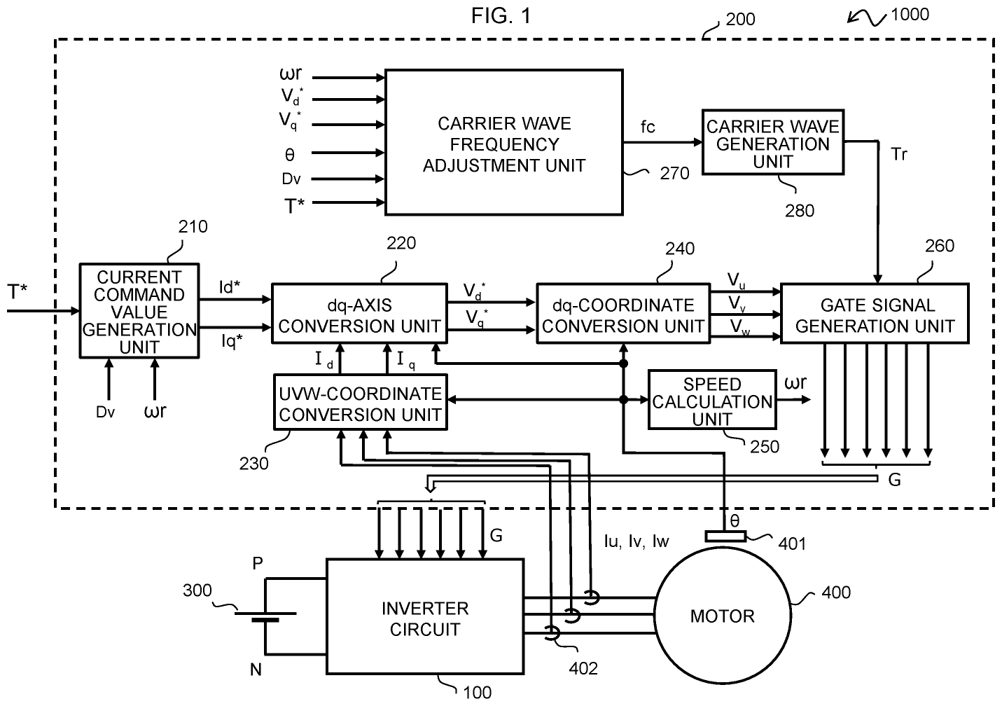

FIG. 1 is a system configuration diagram of the motor control device 1000.

The motor control device 1000 includes an inverter circuit 100 and a control unit 200. The inverter circuit 100 is a power converter that converts DC power to AC power. The inverter circuit 100 comprises three phases of upper and lower arm circuits. Each arm circuit includes a power semiconductor element and a diode for switching. The power semiconductor element performs switching operation by the gate signal G output from the control unit 200. By the switching operation of the power semiconductor element, the inverter circuit 100 converts the DC power supplied from the DC power supply 300 into AC power and outputs a three-phase AC current. The DC power supply 300 is a secondary battery such as a battery. The three-phase AC current output from the inverter circuit 100 is supplied to a motor 400 to drive the motor 400. The motor 400 will be described with an example of a three-phase motor.

The motor 400 is provided with a position detector 401 for detecting the rotation position θ of the motor 400, and the detected rotation position θ is output to the control unit 200. The three-phase AC current between the inverter circuit 100 and the motor 400 is detected by a current detector 402, and the detected current values Iu, Iv, and Iw of each phase are output to the control unit 200.

The motor control device 1000 including the inverter circuit 100 and the control unit 200 is mounted on a vehicle such as an electric vehicle or a hybrid vehicle together with, for example, the DC power supply 300 and the motor 400 to drive the vehicle. In the following description, a power supply operation in which the motor 400 drives the vehicle will be described by way of example, but the same applies to a regenerative operation in which the motor 400 functions as a generator.

Referring to the current values Iu, Iv, and Iw detected by the current detector 402 and the rotation position θ detected by the position detector 401, the control unit 200 calculates a voltage command value corresponding to the torque command T* from the higher controller (not shown). And the control unit 200 outputs the gate signal G generated by the voltage command value and the carrier wave to the inverter circuit 100.

The control unit 200 includes a current command value generation unit 210, a dq-axis conversion unit 220, a UVW-coordinate conversion unit 230, a dq-coordinate conversion unit 240, a speed calculation unit 250, a gate signal generation unit 260, a carrier wave frequency adjustment unit 270, and a carrier wave generation unit 280.

A DC voltage value Dv supplied to the inverter circuit 100, a rotation speed ωr of the motor 400, and a torque command T* are input to the current command value generation unit 210, and the input torque command T* is converted into a d-axis current command value Id* and a q-axis current command value Iq*.

The dq-axis conversion unit 220 converts the d-axis current command value Id* into the d-axis voltage command value Vd* based on the rotation position θ of the motor 400 and the d-axis current value Id obtained by the UVW-coordinate conversion unit 230, and outputs the converted value to the dq-coordinate conversion unit 240. Further, the dq-axis conversion unit 220 converts the q-axis current command value Iq* into the q-axis voltage command value Vq* based on the rotation position θ and the q-axis current value Iq obtained by the UVW-coordinate conversion unit 230, and outputs the converted value to the dq-coordinate conversion unit 240.

The UVW-coordinate conversion unit 230 converts the current values Iu, Iv, and Iw detected by the current detector 402 into the d-axis current value Id and the q-axis current value Iq with reference to the rotation position θ, and outputs the converted value to the dq-axis conversion unit 220.

The d-axis voltage command value Vd*, the q-axis voltage command value Vq*, and the rotation position θ are input to the dq-coordinate conversion unit 240, and the d-axis voltage command value Vd* and the q-axis voltage command value Vq* are converted into the voltage command values Vu, Vv, and Vw of the three UVW phases, and output to the gate signal generation unit 260.

The speed calculation unit 250 calculates the motor rotation speed ωr representing the rotation speed (the number of revolution) of the motor 400 from the time change of the rotation position θ. Note that the motor rotation speed ωr may be a value expressed as either an angular speed (rad/s) or the number of revolution (rpm). These values may be used by converting them into each other.

A gate signal generation unit 260 compares a carrier wave Tr output from the carrier wave generation unit 280 with voltage command values Vu, Vv, Vw, and generates the gate signal G composed of PWM pulses. In other words, the gate signal generation unit 260 performs pulse width modulation on the voltage commands Vu, Vv, Vw corresponding to the torque command T* using the carrier wave Tr, and generates the gate signal G for controlling the operation of the inverter circuit 100.

The carrier wave frequency adjustment unit 270 outputs the carrier wave frequency fc for shifting the phase of the carrier wave used for generating the gate signal G based on the rotation speed (rotor phase angular speed) or of the motor 400, the d-axis voltage command value Vd*, the q-axis voltage command value Vq*, the rotation position θ, the DC voltage value Dv, and the torque command T*.

The carrier wave generation unit 280 generates the carrier wave Tr having a triangular wave shape based on the carrier wave frequency fc and outputs it to the gate signal generation unit 260. The gate signal generation unit 260 compares the carrier wave Tr with the voltage command values Vu, Vv and Vw and generates the gate signal G consisting of PWM pulses.

Although the control unit 200 has been described in terms of a plurality of block configurations, the control unit 200 may be configured by a computer equipped with a CPU, a memory or the like. In this case, the computer performs its processing by executing a program stored in a memory or the like. Further, all or part of the processing of the plurality of blocks may be realized by a hard logic circuit. Further, the program may be stored in a storage medium in advance and provided. Alternatively, the program may be provided by a network line. It may be provided as a computer-readable computer program product in various forms, such as a data signal.

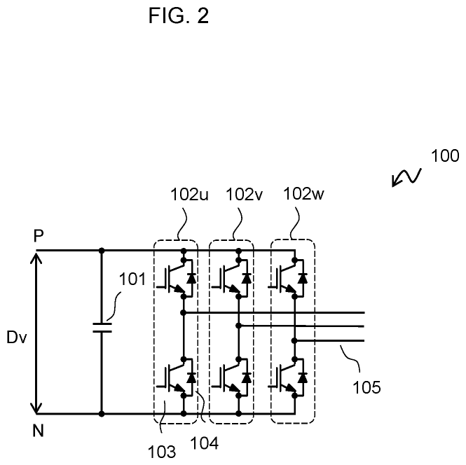

FIG. 2 is a configuration diagram of the inverter circuit 100.

The voltage between the positive electrode P and the negative electrode N on the input side of the inverter circuit 100 is detected by a voltage detector (not shown), and the detected value is a DC voltage value Dv. A smoothing capacitor 101 is provided between the positive electrode P and the negative electrode N. Further, three phases of upper and lower arm circuits 102u, 102v, and 102w are connected between the positive electrode P and the negative electrode N. Each upper and lower arm circuit 102u, 102v, 102w has two power semiconductor elements 103 functioning as switching elements for each upper and lower arm, and diodes 104 provided in parallel with each power semiconductor element 103. The power semiconductor elements 103 are, for example, IGBTs. The power semiconductor elements are switched by the gate signal G from the gate signal generation unit 260. As a result, the DC voltage value Dv is converted into a three-phase AC current, which is output from the upper and lower arm circuits 102u, 102v, and 102w to the windings of each phase of the motor 400 through the AC output lines 105 of each phase.

The cause of the pulsation of the electromagnetic force in the motor 400 is depending on a motor magnetic circuit configured by the stator core, stator coil, rotor core, and rotor magnet of the motor 400, which is caused by the number of magnetic flux linkages and the current. Specifically, the pulsation is caused by the fundamental wave current corresponding to the three-phase voltage commands Vu*, Vv*, and Vw*, that is, the pulsation of each harmonic component whose order is a multiple of 6 among the harmonic components of the fundamental wave current. The pulsation is divided into the pulsating torque, which is a pulsation component generated in the circumferential direction of the motor 400, and the electromagnetic excitation force, which is a pulsation component generated in the radial direction of the motor 400. Hereinafter, the pulsating torque is referred to as the pulsating torque due to the interlinkage magnetic flux.

Further, the other cause of the pulsation of the electromagnetic force in the motor 400 is the change of the electromagnetic force generated by the harmonic wave included in the current supplied from the inverter circuit 100 to the coil of the motor 400 due to the control by the pulse width modulation of the inverter circuit 100. Specifically, the pulsating torque is generated by, among the harmonic components of the command current generated by the pulse width modulation using the carrier wave, each harmonic component whose order is a multiple of 6. Hereinafter, this pulsating torque is referred to as the pulsating torque due to the command current.

The carrier wave frequency adjustment unit 270 adjusts the carrier wave frequency fc of the carrier wave Tr as described above. By adjusting the frequency of the carrier wave Tr, the phase of the pulsating torque caused by the command current is changed. In this embodiment, for example, according to the torque command T* and the rotation speed ωr of the motor 400, the frequency of the carrier wave Tr is adjusted so that the pulsating torque caused by the command current overlaps the pulsating torque caused by the interlinkage magnetic flux of the motor. The overlap of the pulsating torque caused by the command current and the pulsating torque caused by the interlinkage magnetic flux of the motor 400 is such that, for example, the phase difference of each pulsating torque is in the range of ±30 degrees. Thus, the torque of the motor 400 can be increased as necessary.

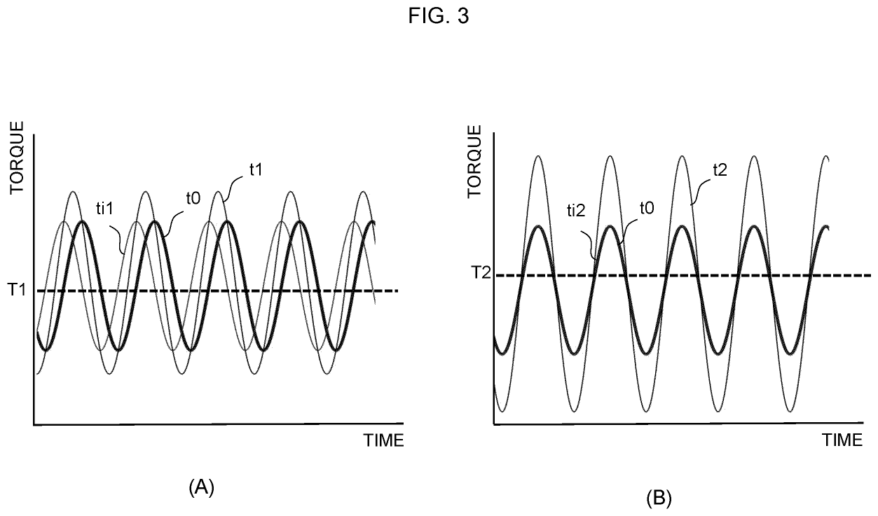

FIGS. 3(A) and 3(B) are diagrams showing pulsating torques. The horizontal axis indicates time, and the vertical axis indicates torque. FIG. 3(A) shows the pulsating torque when the phase of the pulsating torque due to the command current is not changed, and FIG. 3(B) shows the case when the phase of the pulsating torque due to the command current is changed to match the phase of the pulsating torque due to the interlinkage magnetic flux. Both pulsating torques show the pulsating torque due to the harmonic component of 6Nth order (N is the natural number).

As shown in FIG. 3(A), the pulsating torque ti1 due to the command current is shifted in phase from the pulsating torque t0 due to the interlinkage magnetic flux. Therefore, the torque t1 obtained by combining these pulsating torques appears as the pulsating torque of the motor 400. The pulsating torque causes noise and vibration of the motor 400. The average torque of the motor 400 in this case is T1.

Next, the phase of the pulsating torque ti1 caused by the command current is changed to the pulsating torque ti2 as shown in FIG. 3(B), and the phase is completely adjusted to the phase of the pulsating torque t0 caused by the interlinkage magnetic flux. In this case, the torque t2 obtained by combining these pulsating torques appears as the pulsating torque. The amplitude of the torque t2 is larger than that of the torque t1. The average torque T2 of the motor 400 is larger than the average torque T1. In this embodiment, in a situation where the noise and vibration of the motor 400 are not concerned, or in a situation where the torque of the motor 400 is to be preferentially increased, the phase of the pulsating torque ti1 caused by the command current is appropriately changed to increase the torque of the motor 400.

FIG. 3(B) shows an example in which the phase of the pulsating torque ti1 caused by the command current is perfectly adjusted to the phase of the pulsating torque t0 caused by the interlinkage magnetic flux, but it is sufficient that the two is overlapped within a phase difference of ±30 degrees. The magnitude of the torque to be increased can be adjusted by appropriately setting the phase difference between the two within the phase difference range.

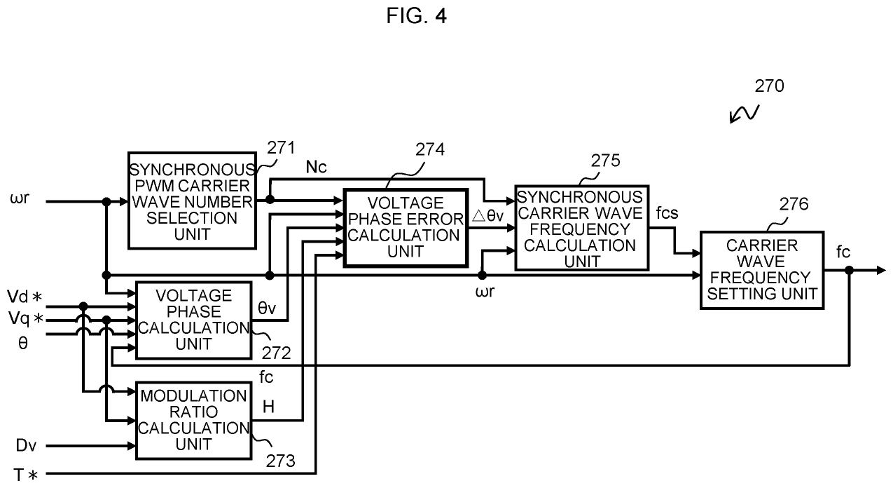

FIG. 4 is a block diagram of the carrier wave frequency adjustment unit 270. The carrier wave frequency adjustment unit 270 includes a synchronous PWM carrier wave number selection unit 271, a voltage phase calculation unit 272, a modulation ratio calculation unit 273, a voltage phase error calculation unit 274, a synchronous carrier wave frequency calculation unit 275, and a carrier wave frequency setting unit 276.

The synchronous PWM carrier wave number selection unit 271 selects a synchronous PWM carrier wave number Nc representing the number of carrier waves Tr for one period of the voltage waveform in the synchronous PWM control based on the rotation speed ωr. For example, the synchronous PWM carrier wave number selection unit 271 selects the synchronous PWM carrier wave number Nc so that the value of Nc±3 or Nc×2 coincides with the order of the pulsating torque (multiple of 6) due to the interlinkage magnetic flux. Specifically, for example, if the rotation speed ωr is less than a predetermined threshold, Nc=15, and if it is greater than or equal to the threshold, Nc=9. As a result, the synchronous PWM carrier wave number Nc corresponding to the order of the pulsating torque due to the interlinkage magnetic flux of the motor 400 can be set to an optimum value according to the rotation speed ωr.

The synchronous PWM carrier wave number selector 271 may select the synchronous PWM carrier wave number Nc based not only on the rotation speed ωr but also on the torque command T*. The selection criterion of the synchronous PWM carrier wave number Nc may be changed when the rotation speed ωr rises and falls, for example, by setting hysteresis.

The voltage phase calculation unit 272 calculates the voltage phase θv based on the d-axis voltage command Vd* and the q-axis voltage command Vq*, the rotation position θ, the rotation speed ωr, and the carrier wave frequency fc according to the following equations (1) to (4).

$$θ v = θ + φ v + φ dqv + 0.5 π \qquad ( 1 )$$

$$φ v = ω r \cdot 1.5 Tc \qquad ( 2 )$$

$$Tc = 1 / fc \qquad ( 3 )$$

$$φ dqv = a tan ( Vq / Vd ) \qquad ( 4 )$$

Here, φv represents the operation delay compensation value of the voltage phase, Tc represents the carrier wave period, and φdqv represents the voltage phase from the d-axis. The operation delay compensation value φv compensates for the occurrence of an operation delay equal to 1.5 control periods between the time when the position detector 401 acquires the rotation position θ and the time when the control unit 200 outputs the gate signal to the inverter circuit 100. In this embodiment, 0.5π is added in the fourth term of the right side of equation (1). Since the voltage phase calculated in the first to third terms of the right side of equation (1) is a cos wave, this is an operation to perform viewpoint transformation on it into a sin wave.

The modulation ratio calculation unit 273 calculates the modulation ratio H based on the d-axis voltage command Vd*, the q-axis voltage command Vq*, and the DC voltage value Dv according to the following equation (5). The modulation ratio H represents the voltage amplitude ratio between the DC power supplied from the DC power supply 300 to the inverter circuit 100 and the AC power output from the inverter circuit 100 to the motor 400.

$$H = √ ( Vd \hat{} 2 + Vq \hat{} 2 ) / ( Dv / 2 ) \qquad ( 5 )$$

The voltage phase error calculation unit 274 calculates the voltage phase error Δθv based on the synchronous PWM carrier wave number Nc selected by the synchronous PWM carrier wave number selection unit 271, the voltage phase θv calculated by the voltage phase calculation unit 272, the modulation ratio H calculated by the modulation ratio calculation unit 273, the rotation speed ωr, and the torque command T*. The voltage phase error Δθv represents the phase difference between the three-phase voltage commands Vu*, Vv*, and Vw*, which are the voltage commands to the inverter circuit 100, and the carrier wave Tr used for pulse width modulation. As the voltage phase error calculation unit 274 calculates the voltage phase error Δθv for each predetermined operation period, the carrier wave frequency adjustment unit 270 can adjust the frequency of the carrier wave Tr so as to change the phase difference between the voltage commands to the inverter circuit 100 and the carrier wave Tr used for pulse width modulation.

The synchronous carrier wave frequency calculation unit 275 calculates the synchronous carrier wave frequency fcs based on the voltage phase error Δθv calculated by the voltage phase error calculation unit 274, the rotation speed ωr, and the synchronous PWM carrier wave number Nc selected by the synchronous PWM carrier wave number selection unit 271 according to the following equation (6).

$$fcs = ω r \cdot Nc \cdot ( 1 + Δθ v \cdot K ) / ( 2 π ) \qquad ( 6 )$$

The synchronous carrier wave frequency calculation unit 275 can calculate the synchronous carrier wave frequency fcs based on the equation (6) by, for example, PLL (Phase Locked Loop) control. In the equation (6), the gain K may be a constant value or may be variable depending on conditions.

Based on the rotation speed ωr, the carrier wave frequency setting unit 276 selects either of the synchronous carrier wave frequency fcs calculated by the synchronous carrier wave frequency calculation unit 275 or the asynchronous carrier wave frequency fcns and outputs it as the carrier wave frequency fc. The asynchronous carrier wave frequency fcns is a fixed value previously set in the carrier wave frequency setting unit 276. A plurality of asynchronous carrier wave frequencies fcns may be prepared in advance, and one of them may be selected according to the rotation speed ωr. For example, the carrier wave frequency setting unit 276 can select the asynchronous carrier wave frequency fcns so that the greater the value of the rotation speed ωr, the greater the value of the asynchronous carrier wave frequency fcns, and output it as the carrier wave frequency fc.

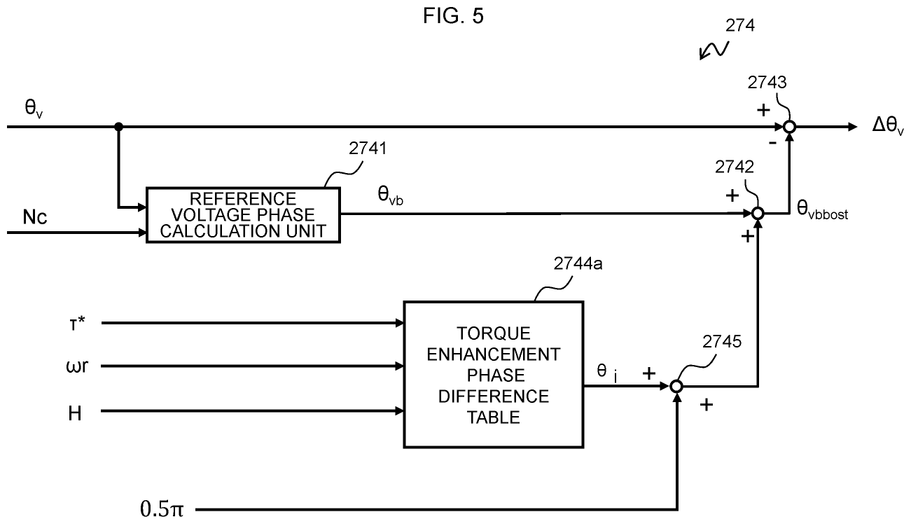

FIG. 5 is a block diagram of the voltage phase error calculation unit 274. The voltage phase error calculation unit 274 includes a reference voltage phase calculation unit 2741, an addition unit 2742, a subtraction unit 2743, a torque enhancement phase difference table 2744a, and a phase difference conversion unit 2745.

Based on the synchronous PWM carrier wave number Nc and the voltage phase θv, the reference voltage phase calculation unit 2741 calculates the reference voltage phase θvb for fixing the phase of the carrier wave Tr in synchronous PWM control. Specifically, the reference voltage phase calculation unit 2741 calculates the reference voltage phase θvb based on the voltage phase θv and the synchronous PWM carrier wave number Nc according to the following equations (7) to (8).

$$θ vb = int ( θ v / θ s ) \cdot θ s + 0.5 θ s \qquad ( 7 )$$

$$θ s = 2 π / Nc \qquad ( 8 )$$

Here, θs represents the change width of the voltage phase θv per carrier wave, and int represents the truncation operation after the decimal point. By performing the calculation of the reference voltage phase θvb by the reference voltage phase calculation unit 2741, the period of the carrier wave Tr with respect to the voltage phase θv and the period of the pulsating torque due to the interlinkage magnetic flux can be matched with each other.

The torque enhancement phase difference table 2744a is a table representing a phase difference for superimposing the pulsating torque due to the command current onto the pulsating torque due to the interlinkage magnetic flux of the motor 400. The phase difference here means a phase difference with respect to the reference voltage phase θvb. This table is set for a plurality of values of the rotation speed ωr, the torque command T*, and the modulation ratio H, respectively. The voltage phase error calculation unit 274 refers to these tables based on the rotation speed ωr, the torque command T*, and the modulation ratio H to specify the phase difference for enhancing the torque.

For example, by simulation or measurement, phase difference data for the reference voltage phase θvb for superimposing the pulsating torque due to the command current to the pulsating torque due to the interlinkage magnetic flux of the motor 400 are previously acquired for each rotation speed ωr, torque command T*, and modulation ratio H. The torque enhancement phase difference table 2744a is respectively set based on these previously acquired phase difference data. The reason why the torque enhancement phase difference table 2744a is set for each modulation ratio H is to compensate that the dominant order of the pulsating torque generated by the harmonic current changes according to the modulation ratio H. The phase difference output based on the torque enhancement phase difference table 2744a may be either the current phase difference θi or the voltage phase difference. In this embodiment, the phase difference output from the torque enhancement phase difference table 2744a is the current phase difference θi, and the phase difference conversion unit 2745 in the subsequent stage converts the current phase difference θi to the voltage phase difference.

The phase difference conversion unit 2745 converts the current phase difference θi to the voltage phase difference by adding 0.5n to the current phase difference θi input from the torque enhancement phase difference table 2744a. The reason for adding 0.5n here is that, since the harmonic current is not easily affected by resistance, the differential value (0.5n advance) of the harmonic current flowing through the inductance component of the motor 400 mainly affects the voltage of the motor 400.

The addition unit 2742 adds the voltage phase difference calculated by the phase difference conversion unit 2745 to the reference voltage phase θvb calculated by the reference voltage phase calculation unit 2741, thereby calculating the corrected reference voltage phase θvbbost to match the phase of the pulsating torque caused by the command current to the phase of the pulsating torque caused by the interlinkage magnetic flux.

The subtraction unit 2743 subtracts the corrected reference voltage phase θvbbost from the voltage phase θv, thereby calculating the voltage phase error Δθv.

The voltage phase error calculation unit 274 calculates the voltage phase error Δθv as described above. Thus, based on the rotation speed ωr, the torque command T*, and the modulation ratio H, the voltage phase error Δθv can be determined so that the phase of the pulsating torque due to the command current is aligned with the phase of the pulsating torque due to the interlinkage magnetic flux. As a result, the carrier wave frequency fc can be set by changing the phase difference between the voltage command to the inverter 3 and the carrier wave Tr used for pulse width modulation so that the pulsating torque due to the command current is overlapped with the pulsating torque due to the interlinkage magnetic flux.

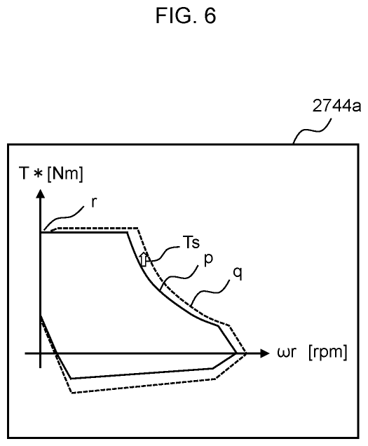

FIG. 6 is a diagram showing the torque enhancement phase difference table 2744a related to Example 1. The rotation speed ωr of the motor 400 is shown on the horizontal axis, and the torque command T* is shown on the vertical axis.

In FIG. 6, the torque enhancement condition for applying the torque enhancement of the motor 400 is stored in accordance with the rotation speed ωr of the motor 400 and the torque command T*. Specifically, when the relationship between the rotation speed ωr and the torque command T* becomes the solid line p shown in FIG. 6, the torque of the motor 400 is enhanced as shown by the dotted line q shown in FIG. 6. The torque Ts shown by the arrow represents the increased torque.

The solid line p is the maximum torque command T* of the motor 400, and the maximum torque command T* gradually decreases as the rotation speed ωr becomes faster. In the low-speed rotation range r when the rotation speed ωr is 0 or slow, the dotted line q overlaps the solid line p. That is, the torque of the motor 400 is not enhanced in this low-speed rotation range r. This is because when the rotation speed ωr is 0 or slow, there is a high possibility of occurrence of vibration of the motor 400 or resonance with the vehicle when the motor 400 is used as the driving source of the vehicle. In FIG. 6, when the torque command T* is a negative value, the motor 400 is regenerated.

The torque enhancement phase difference table 2744a stores the relationship between the rotation speed ωr and the torque command T*, and the current phase difference θi for each modulation ratio H, obtained by simulation or measurement. Here, the current phase difference θi is such a value that the torque to be enhanced becomes the torque Ts by superimposing the pulsating torque due to the command current on the pulsating torque due to the interlinkage magnetic flux.

When the relationship between the rotation speed ωr of the motor 400 and the torque command T* satisfies the torque enhancement condition for applying the torque enhancement of the motor 400, the voltage phase error calculation unit 274 overlaps the pulsating torque caused by the command current with the pulsating torque caused by the interlinkage magnetic flux, thereby outputting the voltage phase error Δθv for which the torque to be enhanced becomes the torque Ts. Thus, when the maximum torque command T* is input, the maximum torque of the motor 400 can be further enhanced as compared with the normal maximum torque.

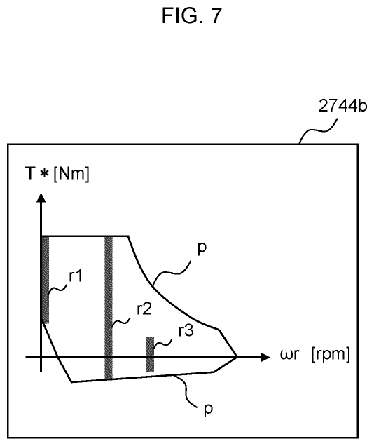

FIG. 7 is a diagram showing the torque enhancement phase difference table 2744b related to Example 2. The rotation speed ωr of the motor 400 is shown on the horizontal axis, and the torque command T* is shown on the vertical axis.

In FIG. 7, the torque enhancement condition for applying the torque enhancement of the motor 400 is stored in accordance with the rotation speed ωr of the motor 400 and the torque command T*. Specifically, the torque of the motor 400 is enhanced when the relationship between the rotation speed ωr and the torque command T* is within the range enclosed by the solid line p shown in FIG. 7 and within the range excluding the ranges r1, r2, and r3.

The range r1 is the low-speed rotation range when the rotation speed ωr is 0 or slow. In this range r1, the torque of the motor 400 is not increased. This is because when the rotational speed ωr is 0 or slow, there is a high possibility of occurrence of vibration of the motor 400 or resonance with the vehicle when the motor 400 is used as the driving source of the vehicle.

The range r2 is a range in which the motor 400 is driven relatively quietly in a steady state, and when the torque of the motor 400 is increased, vibration and sound of the inverter 100, vibration and sound of the motor 400, and vibration and sound caused by resonance with the vehicle using the motor 400 as a driving source of the vehicle are noticeable. The range r3 is a range in which the rotation speed of the motor 400 is increased and vibration of the motor 400 and resonance with the vehicle using the motor 400 as a driving source are noticeable when the torque of the motor 400 is increased. These ranges r1, r2, and r3 are examples, and vibration and sound of the inverter 100, the motor 400, and the vehicle using the motor 400 as a driving source are obtained by simulation or measurement, and when the torque of the motor 400 is enhanced, the range in which vibration and sound are noticeable can be set appropriately.

In the torque enhancement phase difference table 2744b, the relationship between the rotation speed ωr and the torque command T*, and the current phase difference θi for each modulation ratio H is acquired by simulation or actual measurement, and stored. Here, the current phase difference θi is a value that becomes a torque to be enhanced by superimposing the pulsating torque caused by the command current on the pulsating torque caused by the interlinkage magnetic flux.

When the relationship between the rotation speed ωr of the motor 400 and the torque command T* satisfies the torque enhancement condition for applying the torque enhancement of the motor 400, the voltage phase calculation unit 272 outputs the voltage phase θv that becomes the torque to be enhanced by superimposing the pulsating torque by the command current on the pulsating torque by the interlinkage magnetic flux.

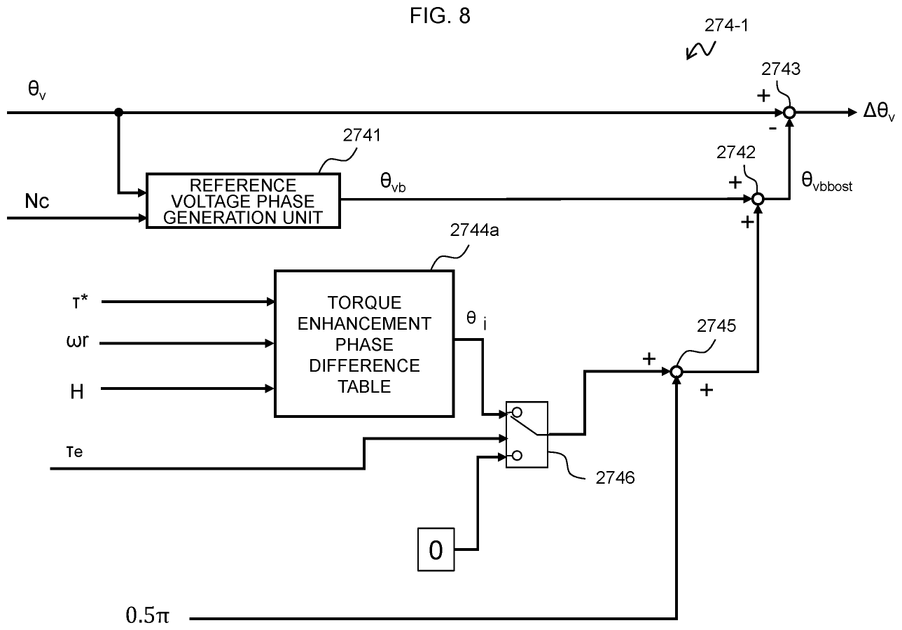

FIG. 8 is a block diagram of the voltage phase error calculation unit 274-1 in Variation 1. Compared with the voltage phase error calculation unit 274 shown in FIG. 5, there is a difference in the fact that torque enhancement can be applied as needed. The same reference signs are given at the same places as the voltage phase error calculation unit 274 shown in FIG. 5, and the description thereof will be omitted.

The voltage phase error calculation unit 274-1 includes the reference voltage phase calculation unit 2741, the addition unit 2742, the subtraction unit 2743, the torque enhancement phase difference table 2744a, the phase difference conversion unit 2745, and a switching unit 2746.

When the torque enhancement instruction Te is input, the switching unit 2746 switches to output the current phase difference θi from the torque enhancement phase difference table 2744a to the phase difference conversion unit 2745. When the torque enhancement instruction Te is not input, it switches to the “0” output side. At the “0” output side, the current phase difference θi from the torque enhancement phase difference table 2744a is not output to the phase difference conversion unit 2745. The torque enhancement instruction Te is output from a control device for a vehicle (not shown) when, for example, the driver depresses the pedal from a vehicle or the like using the motor 400 as a driving source to accelerate the vehicle. In addition, the torque enhancement instruction Te can be appropriately input under a situation where the torque of the motor 400 is desired to be enhanced.

In this variation, an example using the torque enhancement phase difference table 2744a is shown, but the torque enhancement phase difference table 2744b may be used, or a torque enhancement phase difference table in which the current phase difference θi corresponding to the torque command T* and the rotation speed ωr of the motor 400 are defined may be used.

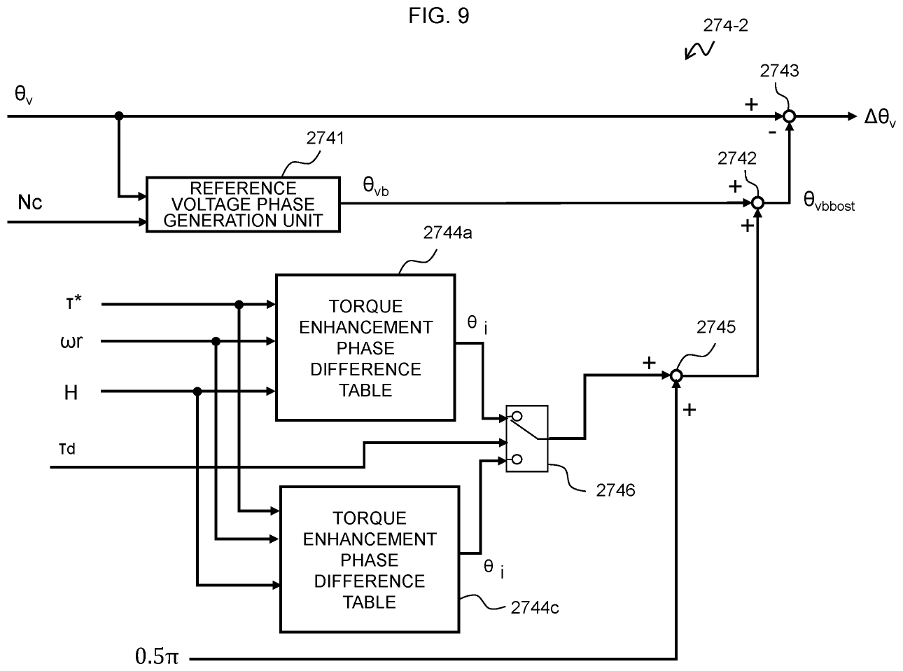

FIG. 9 is a block diagram of the voltage phase error calculation unit 274-2 in Variation 2. Compared with the voltage phase error calculation unit 274-1 shown in FIG. 8, there is a difference in the fact that the torque enhancement can be applied in accordance with the torque command T* and the rotation speed ωr of the motor 400 even during the torque limitation of the motor 400. The same reference signs are given at the same places as the voltage phase error calculation unit 274-1 shown in FIG. 8, and the description thereof will be omitted.

The voltage phase error calculation unit 274-2 includes the reference voltage phase calculation unit 2741, the addition unit 2742, the subtraction unit 2743, the torque enhancement phase difference table 2744a, the phase difference conversion unit 2745, the switching unit 2746, and a torque enhancement phase difference table 2744c.

When the torque limiting signal Td is not input, the switching unit 2746 switches to output the current phase difference θi from the torque enhancement phase difference table 2744a to the phase difference conversion unit 2745. When the torque limiting signal Td is input, the switching unit 2746 switches to output the current phase difference θi from the torque enhancement phase difference table 2744c to the phase difference conversion unit 2745. The torque limiting signal Td is output from the control unit 200 based on the temperature from a temperature sensor (not shown) provided in, for example, the inverter circuit 100, the DC power supply 300 (battery, etc.), the motor 400, etc. When the temperature of the inverter circuit 100, the DC power supply 300 (battery, etc.), the motor 400, etc. exceeds a threshold value, the torque limiting signal Td is output from the control unit 200 for the purpose of limiting the torque of the motor 400 in order to suppress the temperature rise.

Similar to the torque enhancement phase difference table 2744a, the relationship between the rotation speed ωr and the torque command T*, and the current phase difference θi is stored in the torque enhancement phase difference table 2744c for each modulation rate H. When the rotation speed ωr and the torque command T* are in a relatively low range, the current phase difference θi is output so as to enhance the torque. The details of the torque enhancement phase difference table 2744c will be described later.

In this variation, an example using the torque enhancement phase difference table 2744a has been shown, but the torque enhancement phase difference table 2744b may be used, or a torque enhancement phase difference table in which the current phase difference θi corresponding to the torque command T* and the rotation speed ωr of the motor 400 are defined may be used. The torque enhancement phase difference tables 2744a and 2744b may not be provided, but only the torque enhancement phase difference table 2744c may be provided. In this case, when the torque limiting signal Td is input, the current phase difference θi from the torque enhancement phase difference table 2744c is output to the phase difference conversion unit 2745.

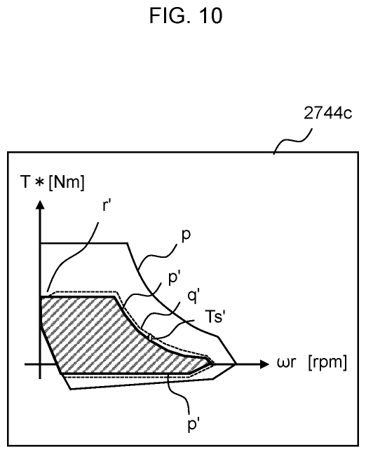

FIG. 10 is a diagram showing the torque enhancement phase difference table 2744c related to Example 3. It is used in the voltage phase error calculation unit 274-2 in the Variation 2 shown in FIG. 9. The rotation speed ωr of the motor 400 is shown on the horizontal axis, and the torque command T* is shown on the vertical axis.

In FIG. 10, the torque enhancement condition for applying the torque enhancement of the motor 400 during the torque limitation is stored according to the rotation speed ωr of the motor 400 and the torque command T*. Specifically, when the relationship between the rotation speed ωr and the torque command T* is within the range enclosed by the solid line p′ shown in FIG. 10, the torque Ts′ indicated by the arrow is enhanced. When the rotation speed ωr and the torque command T* are on the solid line p′, for example, the torque T is enhanced as shown by the dotted line q′ shown in FIG. 10. In the low-speed rotation range r′ when the rotation speed ωr is 0 or slow, the dotted line q′ overlaps the solid line p. That is, when the torque command T* is the maximum in the low-speed rotation range r′, the torque of the motor 400 is not increased to avoid vibration of the motor 400 and resonance with the vehicle.

In FIG. 10, when the torque command T* is a negative value, the motor 400 is regenerated. The solid line p indicates the maximum torque command T* of the motor 400 with respect to the rotation speed ωr. The range enclosed by the solid line p′ is set inside the solid line p. This indicates that the range enclosed by the solid line p′ is a range where the rotation speed ωr and the torque command T* are relatively low. In the range enclosed by the solid line p′, even when the torque is limited, the influence on the inverter circuit 100, the DC power supply 300 (battery, etc.), the motor 400, etc. can be suppressed even when the torque is increased by controlling the current phase difference θi.

In the torque enhancement phase difference table 2744c, the relationship between the rotation speed ωr and the torque command T*, and the current phase difference θi during the torque limitation acquired by simulation, measurement, etc., is recorded for each modulation ratio H. Here, the current phase difference θi is the value at which the torque to be enhanced becomes the torque Ts′ by superimposing the pulsating torque caused by the command current on the pulsating torque caused by the interlinkage magnetic flux.

The voltage phase error calculation unit 274-2 outputs the voltage phase error Δθv in which the torque to be enhanced becomes the torque Ts′ by superimposing the pulsating torque due to the command current on the pulsating torque due to the interlinkage magnetic flux when the torque limiting signal Td indicating that the torque is being limited is input and the relationship between the rotation speed ωr of the motor 400 and the torque command T* satisfies the torque enhancing condition for applying the torque enhancement of the motor 400. Thus, the torque of the motor 400 can be enhanced even during the torque limitation.

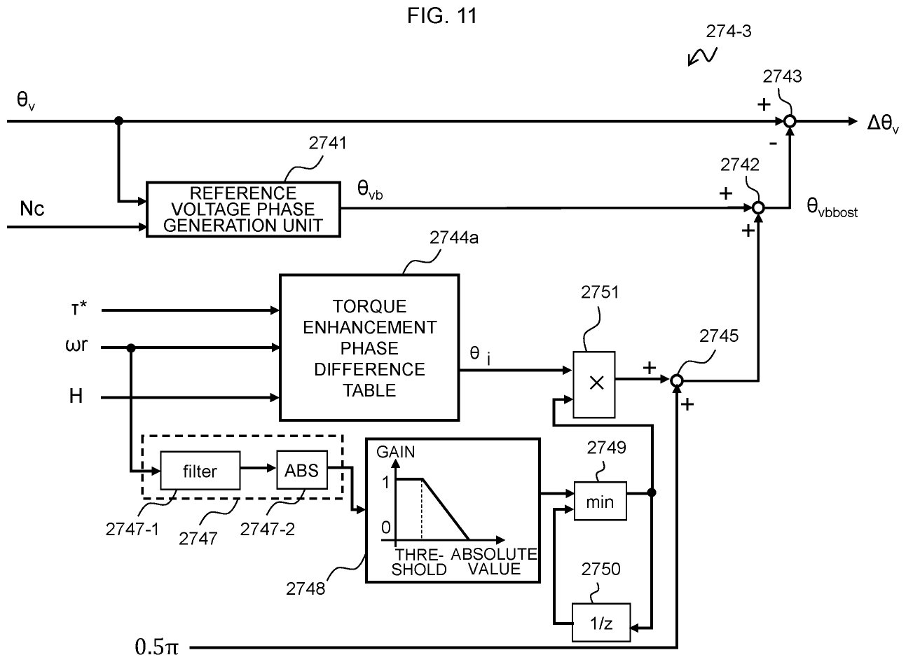

FIG. 11 is a block diagram of the voltage phase error calculation unit 274-3 in Variation 3. Compared with the voltage phase error calculation unit 274-1 shown in FIG. 8, there is a difference in controlling torque enhancement in response to vibration of the motor 400 or the like. The same reference signs are given at the same places as the voltage phase error calculation unit 274-1 shown in FIG. 8, and the description thereof will be omitted.

The voltage phase error calculation unit 274-3 includes the reference voltage phase calculation unit 2741, the addition unit 2742, the subtraction unit 2743, the torque enhancement phase difference table 2744a, the phase difference conversion unit 2745, a vibration detection unit 2747, a vibration gain table 2748, a minimum value selection unit 2749, a previous value output unit 2750, and a multiplication unit 2751.

The vibration detection unit 2747 includes a filter section 2747-1 and an absolute value output section 2747-2. The rotation speed ωr of the motor 400 is input to the filter section 2747-1, and the filter section 2747-1 selects and outputs a fluctuation waveform related to vibration among the fluctuation waveforms of the rotation speed ωr. The absolute value output section 2747-2 outputs an absolute value corresponding to the amplitude of the fluctuation waveform output from the filter section 2747-1 as time series data.

Gains corresponding to absolute values are set and stored in advance in the vibration gain table 2748, and a gain is output according to the absolute value input from the absolute value output section 2747-2. For example, as shown in FIG. 11, the vibration gain table 2748 outputs a gain ‘1’ until the absolute value exceeds the threshold, and when the absolute value exceeds the threshold, outputs a gain gradually decreased from ‘1’ as the absolute value increases.

The minimum value selection unit 2749 compares the gain output from the vibration gain table 2748 with the previous gain output from the previous value output unit 2750, and outputs the smaller gain to the multiplication unit 2751. The initial value of the previous value output unit 2750 is ‘1’. When the gain from the vibration gain table 2748 changes suddenly to a large gain, the previous value output unit 2750 suppresses it.

As described above with reference to FIG. 6, the torque enhancement phase difference table 2744a stores the relationship between the rotation speed ωr and the torque command T*, and the current phase difference θi for each modulation ratio H. The multiplication unit 2751 multiplies the gain selected by the minimum value selection unit 2749 with the current phase difference θi output from the torque enhancement phase difference table 2744a, and outputs the current phase difference θi corresponding to the gain. For example, when the vibration of the motor 400 is detected due to the variation of the rotation speed ωr of the motor 400, the current phase difference θi set in the torque enhancement phase difference table 2744a is multiplied by the gain which decreases according to the magnitude of the vibration. Thus, the current phase difference θi is reduced according to the magnitude of the vibration.

When the relationship between the rotation speed ωr of the motor 400 and the torque command T* satisfies the torque enhancement condition for applying the torque enhancement of the motor 400, the voltage phase error calculation unit 274-3 outputs the voltage phase error Δθv that becomes a suppressed torque in response to the vibration of the motor 400. As a result, since the torque enhancement when the vibration of the motor 400 is large is suppressed, it is possible to appropriately enhance the torque while preventing excessive vibration of the motor 400.

In this variation, the vibration detection unit 2747 detects the vibration of the motor based on the rotation speed ωr of the motor 400. For example, in a vehicle driven by the motor 400, the vibration of the vehicle may be detected based on the left, right, front, back, or up and down acceleration of the vehicle detected by an acceleration sensor provided in the vehicle. Although the torque enhancement phase difference table 2744a is used as an example, the torque enhancement phase difference table 2744b may be used, or a torque enhancement phase difference table in which the current phase difference θi corresponding to the torque command T* and the rotation speed ωr of the motor 400 are defined may be used.

According to the above-described embodiment, the following effects can be obtained.
(1) The motor control device 1000 controls the drive of the motor 400 connected to a power converter (inverter circuit 100) that converts DC power to AC power and driven by AC power. It includes the carrier wave generation unit 280 for generating a carrier wave, the carrier wave frequency adjustment unit 270 that adjusts frequency of the carrier wave, and the gate signal generation unit 260 that generates a gate signal for controlling the operation of the power converter (inverter circuit 100) by performing pulse width modulation of the voltage command corresponding to the torque command using the carrier wave. The carrier wave frequency adjustment unit 270 adjusts the frequency of the carrier wave in accordance with the torque command and the rotation speed of the motor 400 so that the phase of the pulsating torque due to the command current generated by the pulse width modulation using the carrier wave overlaps the phase of the pulsating torque due to the interlinkage magnetic flux of the motor 400 within a predetermined phase difference. Thus, the torque of the motor can be increased as necessary.
(2) The motor control method in a motor control device 1000 that controls the driving of the motor 400 connected to a power converter (inverter circuit 100) performing power conversion from DC power to AC power, and driven using the AC power, includes generating a carrier wave, adjusting the frequency of the carrier wave, generating the gate signal for controlling the operation of the power converter (inverter circuit 100) by performing pulse width modulation of the voltage command corresponding to the torque command using the carrier wave, and adjusting the frequency of the carrier wave in accordance with the torque command and the rotation speed of the motor so that the phase of the pulsating torque due to the command current generated by the pulse width modulation using the carrier wave overlaps the phase of the pulsating torque due to the interlinkage magnetic flux of the motor 400 within a predetermined phase difference. Thus, the torque of the motor can be increased as necessary.

The present invention is not limited to the embodiments described above, but also includes other modifications considered within the scope of the technical concept of the present invention, so long as they do not impair the features of the present invention. Further, the above embodiments may be combined with a plurality of variations.

Reference Signs List

100 inverter circuit, 102u, 102v, 102w upper and
lower arm circuit, 103 power semiconductor element,
200 control unit, 210 current command value generation
unit, 220 dq-axis conversion unit, 230 UVW-coordinate
conversion unit, 240 dq-coordinate conversion unit, 250
speed calculation unit, 260 gate signal generation unit,
270 carrier wave frequency adjustment unit, 280
carrier wave generation unit, 271 synchronous PWM
carrier wave number selection unit, 272 voltage phase
calculation unit, 273 modulation ratio calculation unit,
274, 274-1, 274-2, 274-3 voltage phase error calculation
unit, 275 synchronous carrier wave frequency calculation
unit, 276 carrier wave frequency setting unit, 300
DC power supply, 400 motor, 402 current detector,
1000 motor control device, 2741 reference voltage phase
calculation unit, 2742 addition unit, 2743
subtraction unit, 2744a, 2744b, 2744c torque enhancement
phase difference table, 2745 phase difference conversion
unit, 2746 switching unit, 2747 vibration detection
unit, 2747-1 filter section, 2747-2 absolute value
output section, 2748 vibration gain table, 2749
minimum value selection unit, 2750 previous value output
unit, 2751 multiplication unit.

1. A motor control device that controls driving of a motor connected to a power converter performing power conversion from DC power to AC power, the motor driven using the AC power, comprising:
a carrier wave generation unit that generates a carrier wave;
a carrier wave frequency adjustment unit that adjusts frequency of the carrier wave; and
a gate signal generation unit that generates a gate signal for controlling operation of the power converter by performing pulse width modulation of a voltage command corresponding to a torque command using the carrier wave; wherein
the carrier wave frequency adjustment unit adjusts the frequency of the carrier wave in accordance with the torque command and the rotation speed of the motor so that a phase of pulsating torque due to command current generated by the pulse width modulation using the carrier wave overlaps a phase of pulsating torque due to interlinkage magnetic flux of the motor within a predetermined phase difference.

2. The motor control device according to claim 1, wherein
the predetermined phase difference is within a range of 30 degrees.

3. The motor control device according to claim 1, wherein
the carrier wave frequency adjustment unit adjusts the frequency of the carrier wave when a relationship between the torque command and the rotation speed of the motor satisfies a torque enhancement condition.

4. The motor control device according to claim 3, wherein
the torque enhancement condition is a case where the torque command indicates a maximum torque command.

5. The motor control device according to claim 4, wherein
the torque enhancement condition is a case where the torque command indicates a maximum torque command and the rotation speed of the motor does not include a low speed range.

6. The motor control device according to claim 3, wherein
the torque enhancement condition is a case where the relationship between the torque command and the rotation speed of the motor is within a specified range.

7. The motor control device according to claim 3, wherein
the carrier wave frequency adjustment unit adjusts the frequency of the carrier wave when a torque enhancement instruction for instructing torque enhancement of the motor is input and the torque enhancement condition is satisfied.

8. The motor control device according to claim 3, wherein
the carrier wave frequency adjustment unit adjusts the frequency of the carrier wave when a torque limiting signal indicating during torque limitation is input and the torque enhancement condition is satisfied.

9. The motor control device according to claim 3, wherein
the carrier wave frequency adjustment unit adjusts the frequency of the carrier wave when it detects vibration of the motor or a vehicle on which the motor is mounted, and when the torque enhancement condition is satisfied.

10. The motor control device according to claim 9, wherein
the carrier wave frequency adjustment unit adjusts the frequency of the carrier wave according to a magnitude of the vibration of the motor or the vehicle.

11. The motor control device according to claim 3, wherein
the carrier wave frequency adjustment unit adjusts the frequency of the carrier wave when the torque enhancement condition is satisfied in regenerative operation of the motor.

12. The motor control device according to claim 1, wherein
the pulsating torque due to the command current is a harmonic component of 6Nth order (where N is a natural number).

13. A motor control method in a motor control device that controls driving of a motor connected to a power converter performing power conversion from DC power to AC power, the motor driven using the AC power, comprising:
generating a carrier wave;
adjusting frequency of the carrier wave;
generating a gate signal for controlling operation of the power converter by performing pulse width modulation of a voltage command corresponding to a torque command using the carrier wave; and
adjusting the frequency of the carrier wave in accordance with the torque command and the rotation speed of the motor so that a phase of pulsating torque due to command current generated by the pulse width modulation using the carrier wave overlaps a phase of pulsating torque due to interlinkage magnetic flux of the motor within a predetermined phase difference.
